(19) United States
(12) Patent Application Publication
(10) Pub. No.: US 2024/0191564 A1
(43) Pub. Date: Jun. 13, 2024

(54) A SEAL COMBINATION WITH A LOWER SEAL PART HOLDING A BRUSH OR FIBRE MATERIAL RELEASABLY SECURED TO AN UPPER SEAL PART AND A SEAL WITH A LOWER FLEXIBLE SEAL PART

(71) Applicant: HCF Byg ApS, Holte (DK)

(72) Inventor: Claus FRIMAND, Holte (DK)

(73) Assignee: HCF Byg ApS, Holte (DK)

(21) Appl. No.: 18/551,487

(22) PCT Filed: Mar. 15, 2022
(86) PCT No.: PCT/DK2022/050048

§ 371 Date: Sep. 20, 2023

(30) Foreign Application Priority Data
Mar. 25, 2021 (DK) PA202170134

(51) Int. Cl. E06B 7/23; E04B 1/68; E06B 7/26

(52) U.S. Cl. CPC E06B 7/2316; E04B 1/68; E06B 7/26

(57) ABSTRACT

A seal combination including an upper seal part formed at least partly by a flexible material and a lower seal part holding a brush or fibre material is provided. The lower seal part has a top part releasably secured to a bottom part of the upper seal part and extends in the longitudinal direction of the upper seal part along said bottom part. A top part of the lower seal part is provided with a strip of hook or loop fasteners, and the bottom part of the upper seal part is provided with loop or hook fasteners mating with the strip of hook or loop fasteners provided at the lower seal part to thereby releasably secure the lower seal part to the upper seal part. There is also provided a seal having an upper seal part and a lower flexible seal part with a thickness being smaller than the thickness of the upper seal part.

### TECHNICAL FIELD

The disclosure relates to a seal combination or seal for sealing a space, such as a space between an edge of a wall, fence, a door or sliding door, door leaf or door wing, port or window and an adjacent surface to avoid entrance of for example unwanted animals, insects, or water between the edge of the wall, fence, door or window and the surface. The unwanted animals or water may include rats, mice, rainwater, sewage water, and water from flooding. The structure or seal may also help in preventing temperature changes across the sealed space.

### BACKGROUND

A general problem of entryway design for buildings relates to the dual issues of excluding inclement weather and animals or vermin from entering or impacting the interior when the entryway is shut. One category of known sealing strips for excluding inclement weather comprises flexible synthetic or rubber strips, which are installed at the perimeter of the door at an entryway. Another category of flexible strips for controlling internal temperature are manufactured with rows of tightly packed bristles.

However, vermin are wily and persistent in the face of currently-known flexible barriers, which are keeping them from shelter and/or food. The term vermin relates to animals considered to be pests, including rats and mice. Synthetic or rubber or bristle strips may present a challenge but not a lasting one, and especially rats or mice will find a way in to reach any available food.

Thus, there is a need for an improved seal being both reinforced and flexible and which is able to maintain the reinforcement and flexibility during use.

Strip brushes are commonly used as weather or pest seals for turning or sliding doors, where the brushes are secured to the bottom part of a metal rail, and where the upper part of the metal rail is secured at the bottom of the door. However, when using a non-flexible metal rail for securing the sealing brushes to the door, there is a problem in that the end parts of a metal rail may be deformed during use, leaving a space open at the end of the rail. The commonly used strip brushes, which are installed at the perimeter of the door or sliding door at an entryway, have an advantage in that the bristles or brushes are very flexible and can follow irregularities, such as irregularities on a ground surface adjacent to door or sliding door. However, the bristles or brushes get worn out during use, requiring that the bristles or brushes has to be replaced at regular intervals, which is both costly and time consuming.

Thus, there is a need for an improved seal having the advantages of the known sealing strips holding packed bristles or fibre brushes, but which allows a quick and easy replacement of worn out bristles or brushes.

### SUMMARY

It is an object of the invention to provide an improved structure, seal, seal strip, seal assembly or seal combination, which has the advantages of the known sealing strips holding packed bristles or fibre brushes, but which allows a quick and easy replacement of worn out bristles or brushes.

This object is achieved in accordance with a first aspect by providing a seal combination comprising an upper seal part formed at least partly by a flexible material and a lower seal part holding a brush or fibre material, wherein:
the upper seal part has a length, a width and a maximum thickness, first and second outer sidewalls, a bottom part and a top part, and extends in a longitudinal direction;
the lower seal part has a top part releasably secured to the bottom part of the upper seal part and extends in the longitudinal direction of the upper seal part along said bottom part; and
the top part of the lower seal part is provided with a strip of hook or loop fasteners, and the bottom part of the upper seal part is provided with loop or hook fasteners mating with the strip of hook or loop fasteners provided at the lower seal part to thereby releasably secure the lower seal part to the upper seal part.

By having the lower seal part holding the brush or fibre material, which could be a row of tightly packed bristles, releasably connected to the upper sealing part by use of mating loop and hook fasteners, the lower seal part can easily be removed from the upper seal part and replaced by a new lower seal part holding the brush or fibre material, without having to replace the upper seal part.

In a possible implementation form of the first aspect, the brush or fibre material may be a plastic material, such as a nylon material, formed as a strip brush or bristle strip.

In a possible implementation form of the first aspect, the upper seal part is provided with loop or hook fasteners by a flexible fabric or web like sheet holding loop or hook fasteners, said flexible fabric or web like sheet being secured to the upper seal part and bent around the bottom part of the upper seal part with the loop or hook fasteners facing outwards from the upper seal part.

In a possible implementation form of the first aspect, the top part of the lower seal part is provided with a strip of hook fasteners, and the bottom part of the upper seal part is provided with loop fasteners mating with the strip of hook fasteners provided at the lower seal part to thereby releasably secure the lower seal part to the upper seal part.

In a possible implementation form of the first aspect, the upper seal part is provided with loop fasteners by a flexible fabric or web like sheet holding loop fasteners, said flexible fabric or web like sheet being secured to the upper seal part and bent around the bottom part of the upper seal part with the loop fasteners facing outwards from the upper seal part.

In a possible implementation form of the first aspect the strip of hook or loop fasteners is secured to the top part of the lower seal part by use of an adhesive or by use of tape, such as double-sided tape.

In a possible implementation form of the first aspect the strip of hook or loop fasteners is sewed to the top part of the lower seal part.

In a possible implementation form of the first aspect, the flexible fabric or web like sheet holding hook or loop fasteners is secured to the upper seal part by use of an adhesive or by use of tape, such as double-sided tape.

In a possible implementation form of the first aspect, the flexible fabric or web like sheet holding hook or loop fasteners is sewed to the upper seal part.

In a possible implementation form of the first aspect, the brush or fibre material of the lower seal part extends below the bottom part of the upper seal part, with an extension being no larger than 6 mm, such as no larger than 5 mm, or such a no larger than 4 mm.

In a possible implementation form of the first aspect, at least one half, such as at least two thirds of the surface of the first and/or second outer sidewall of the upper seal part is provided with loop or hook fasteners by said flexible fabric or web like sheet.

In a possible implementation form of the first aspect, the whole surface of the first and/or second outer sidewall of the upper seal part is provided with loop or hook fasteners by said flexible fabric or web like sheet.

In a possible implementation form of the first aspect, the whole surface of both the first and second outer sidewalls of the upper seal part is provided with loop or hook fasteners by said flexible fabric or web like sheet.

In a possible implementation form of the first aspect, the length of brush or fibre material of the lower seal part is smaller than or equal to ¼, ⅕ or ⅙ of the width of the upper seal part.

In a possible implementation form of the first aspect, the top part of the lower seal part has a width, which is substantially equal to or no larger than the maximum thickness of the upper seal part.

In a possible implementation form of the first aspect, the upper seal part is a reinforced flexible seal part comprising:
a flexible outer material; and
a plurality of elongated metal wires embedded in the flexible outer material and running substantially in a longitudinal direction of the reinforced flexible seal part with at least part of said elongated metal wires arranged at a distance to each other.

By having the embedded metal wires running substantially in a longitudinal direction of the reinforced flexible seal and at a distance to each other, the seal is reinforced while being flexible around an axis parallel to the longitudinal direction of the reinforced flexible seal or parallel to the longitudinal direction of the elongated metal members or metal wires.

In a possible implementation form of the first aspect, for which the upper seal part is a reinforced flexible seal part, then for at least one of the embedded elongated metal the wires, at least part of said metal wire holds several bent, bulging or wavelike deformations in the longitudinal direction of the wire.

In a possible implementation form of the first aspect, for which the upper seal part is a reinforced flexible seal part, all the elongated metal members or metal wires of the reinforced flexible seal part are arranged substantially parallel to each other.

In a possible implementation form of the first aspect, for which the upper seal part is a reinforced flexible seal part, the successively arranged elongated metal members or metal wires are arranged with substantially equal spacing.

In a possible implementation form of the first aspect, for which the upper seal part is a reinforced flexible seal part, the bottom part of the upper seal part has an outer edge, and the spacing between said outer edge and an outermost positioned elongated metal member or metal wire is smaller than said substantially equal spacing.

In a possible implementation form of the first aspect, for which the upper seal part is a reinforced flexible seal part, only elongated metal members or metal wires are embedded in the flexible outer material of the reinforced flexible seal part.

In a possible implementation form of the first aspect, a substantially U-shaped metal rail having a length, a bottom wall, and first and second sidewalls is arranged at the upper seal part with the bottom wall covering the top part of the upper seal part, the first sidewall covering a part of the first outer sidewall of the upper seal part, and the second sidewall covering a part of the second outer sidewall of the upper seal part. Here, at least one third of the surface of the first and second outer sidewalls of the upper seal part may be covered by the sidewalls of said metal rail.

According to a second aspect, there is provided a sealed wall, fence, door, sliding door, port or window assembly for sealing a gap or space between an outer edge of a wall, fence, door, sliding door, port or window and a surface adjacent to the wall, fence, door, sliding door, port or window, said assembly comprising:
a wall, fence, door, sliding door, port or window with an outer edge part; and
a seal combination according to any one of the implementation forms of the first aspect having loop or hook fasteners provided at the first or second sidewall of the upper seal part;
wherein the outer edge part of the wall, fence, door, sliding door, port or window is provided with hook or loop fasteners by a flexible fabric or web like sheet holding hook or loop fasteners, said flexible fabric or web like sheet being secured to said outer edge part with the hook or loop fasteners facing outwards from the outer edge part; and
wherein the upper part of the seal combination is releasably secured to the outer edge part of the wall, fence, door, sliding door, port or window with the loop or hook fasteners provided at the first or second sidewall of the upper seal part mating with the of hook or loop fasteners provided at the outer edge part.

In a possible implementation form of the second aspect, the seal combination is secured to the outer edge part of the wall, fence, door, sliding door, port or window with the bottom part of the upper seal part and the lower seal part holding the brush or fibre material extending below or out from the outer edge of the wall, fence, door, sliding door, port or window, to thereby seal the gap or space between the outer edge of the wall, fence, door, sliding door, port or window and the adjacent surface.

In a possible implementation form of the second aspect, the outer edge part of the wall, fence, door, sliding door, port or window is provided with hook fasteners by a flexible fabric or web like sheet holding hook fasteners, said flexible fabric or web like sheet being secured to said outer edge part with the hook fasteners facing outwards from the outer edge part; and
the upper part of the seal combination is releasably secured to the outer edge part of the wall, fence, door, sliding door, port or window with the loop fasteners provided at the first or second sidewall of the upper seal part mating with the hook fasteners provided at the outer edge part.

In a possible implementation form of the second aspect, the flexible fabric or web like sheet holding hook or loop fasteners secured to the outer edge part is secured to said outer edge part by use of an adhesive or by use of tape, such as double-sided tape.

According to a third aspect there is provided a seal comprising an upper seal part formed at least partly by a flexible material and a lower seal part formed by said flexible material, wherein:
the upper seal part has a length, a width and a maximum thickness, first and second outer sidewalls, a bottom part and a top part, and extends in a longitudinal direction;
the lower seal part has a length, a width being smaller than the width of the upper seal part and a lower edge with an edge-thickness which is smaller than the maximum thickness of the upper seal part, said edge-thickness being smaller than or equal to ½, ⅓ or ¼ of the maximum thickness of the upper seal part.

By having a rather thin lower flexible seal part, the flexibility of the bottom of the seal is increased, thereby allowing the bottom of the seal to better follow irregularities, such as irregularities on a ground surface adjacent to a door or sliding door.

In a possible implementation form of the third aspect, the edge-thickness of the lower seal part is smaller than or equal to ⅕ of the maximum thickness of the upper seal part.

In a possible implementation form of the third aspect, the lower seal part has a thickness, which decreases along the width of the lower seal part from a connection point between the upper seal part and the lower seal part towards the lower edge of the lower seal part.

In a possible implementation form of the third aspect, the length of the lower seal part is substantially equal to the length of the upper seal part.

In a possible implementation form of the third aspect, the width of the lower seal part is smaller than or equal to ¼, ⅕ or ⅙ of the width of the upper seal part.

In a possible implementation form of the third aspect, the upper seal part is a reinforced flexible seal part comprising:
a flexible outer material; and
a plurality of elongated metal wires embedded in the flexible outer material and running substantially in a longitudinal direction of the reinforced flexible seal part with at least part of said elongated metal wires arranged at a distance to each other.

In a possible implementation form of the third aspect, for which the upper seal part is a reinforced flexible seal part, at least part of said metal wire holds several bent, bulging or wavelike deformations in the longitudinal direction of the wire.

In a possible implementation form of the third aspect, for which the upper seal part is a reinforced flexible seal part, all the elongated metal members or metal wires of the reinforced flexible seal part are arranged substantially parallel to each other.

In a possible implementation form of the third aspect, for which the upper seal part is a reinforced flexible seal part, the successively arranged elongated metal members or metal wires are arranged with substantially equal spacing.

In a possible implementation form of the third aspect, for which the upper seal part is a reinforced flexible seal part, the bottom part of the reinforced flexible seal part has an outer edge, and the spacing between said outer edge and an outermost positioned elongated metal member or metal wire is smaller than said substantially equal spacing.

In a possible implementation form of the third aspect, the upper seal part is at least partly provided with loop or hook fasteners by a flexible fabric or web like sheet holding loop or hook fasteners and secured to the upper seal part with the loop or hook fasteners facing outwards from the upper seal part. Here, at least one third, or at least one half, or such as at least two thirds of the surface of the first and/or second outer sidewall of the upper seal part may be provided with loop or hook fasteners by said flexible fabric or web like sheet. The flexible fabric or sheet may be bent around the top part of the upper seal part with the loop or hook fasteners facing outwards from the upper seal part.

In a possible implementation form of the third aspect, a substantially U-shaped metal rail having a length, a bottom wall, and first and second sidewalls is arranged at the upper seal part with the bottom wall covering the top part of the upper seal part, the first sidewall covering a part of the first outer sidewall of the upper seal part, and the second sidewall covering a part of the second outer sidewall of the upper seal part. Here, at least one third of the surface of the first and second outer sidewalls of the upper seal part may be covered by the sidewalls of said metal rail.

According to a fourth aspect, there is provided a sealed wall, fence, door, sliding door, port or window assembly for sealing a gap or space between an outer edge of a wall, fence, door, sliding door, port or window and a surface adjacent to the wall, fence, door, sliding door, port or window, said assembly comprising:
a wall, fence, door, sliding door, port or window with an outer edge part; and
a seal according to any one of the implementation forms of the third aspect having loop or hook fasteners provided at the first or second sidewall of the upper seal part;
wherein the outer edge part of the wall, fence, door, sliding door, port or window is provided with hook or loop fasteners by a flexible fabric or web like sheet holding hook or loop fasteners, said flexible fabric or web like sheet being secured to said outer edge part with the hook or loop fasteners facing outwards from the outer edge part; and
wherein the upper part of the seal is releasably secured to the outer edge part of the wall, fence, door, sliding door, port or window with the loop or hook fasteners provided at the first or second sidewall of the upper seal part mating with the of hook or loop fasteners provided at the outer edge part.

In a possible implementation form of the fourth aspect, the seal is secured to the outer edge part of the wall, fence, door, sliding door, port or window with the bottom part of the upper seal part and the lower seal part extending below or out from the outer edge of the wall, fence, door, sliding door, port or window, to thereby seal the gap or space between the outer edge part of the wall, fence, door, sliding door, port or window and the adjacent surface.

In a possible implementation form of the fourth aspect, the outer edge part of the wall, fence, door, sliding door, port or window is provided with hook fasteners by a flexible fabric or web like sheet holding hook fasteners, said flexible fabric or web like sheet being secured to said outer edge part with the hook fasteners facing outwards from the outer edge part; and
the upper part of the seal is releasably secured to the outer edge part of the wall, fence, door, sliding door, port or window with the loop fasteners provided at the first or second sidewall of the upper seal part mating with the of hook fasteners provided at the outer edge part.

In a possible implementation form of the fourth aspect, the flexible fabric or web like sheet holding hook or loop fasteners secured to the outer edge part is secured to said outer edge part by use of an adhesive or by use of tape, such as double-sided tape.

According to a fifth aspect, there is provided a sealed wall, fence, door, sliding door, port or window assembly for sealing a gap or space between an outer edge of a wall, fence, door, sliding door, port or window and a surface adjacent to the wall, fence, door, sliding door, port or window, said assembly comprising:
a wall, fence, door, sliding door, port or window with an outer edge part; and
a seal according to any one of the implementation forms of the first or third aspects having the substantially U-shaped metal rail arranged at the upper seal part;
wherein the upper seal part holding said substantially U-shaped metal rail is secured to the outer edge part of the wall, fence, door, sliding door, port or window by use of several screws, with each screw going through the first sidewall of the metal rail, the upper seal part, the second sidewall of the metal rail, and into said outer edge part.

In a possible implementation form of the fifth aspect, the seal is secured to the outer edge part of the wall, fence, door, sliding door, port or window with the bottom part of the upper seal part and the lower seal part extending below or out from the outer edge of the wall, fence, door, sliding door, port or window, to thereby seal the gap or space between the outer edge part of the wall, fence, door, sliding door, port or window and the adjacent surface.

In a possible implementation form of the first aspect or third aspect, for which the upper seal part is a reinforced flexible seal part, only elongated metal members or metal wires are embedded in the flexible outer material of the reinforced flexible seal part.

In a possible implementation form of the first aspect or third aspect, for which the upper seal part is a reinforced flexible seal part, at least part of or all the elongated metal members or metal wires extend in the whole length of the reinforced flexible seal part.

In a possible implementation form of the first aspect or third aspect, the flexible material or flexible outer material of the upper seal part comprises a flexible plastic material, such as flexible polyvinyl chloride, PVC, and/or wherein the flexible outer material comprises a rubber material.

In a possible implementation form of the first aspect or third aspect, the flexible material or flexible outer material of the upper seal part comprises a thermoplastic elastomer, TPE, type material.

In a possible implementation form of the first aspect or third aspect, the flexible material or flexible outer material of the upper seal part has a shore hardness, Shore A, of not below 40, such as not below 50, such as not below 60, such as not below 65, such as not below 70, such as not below 75, such as in the range of 75-80.

In a possible implementation form of the first aspect or third aspect, the flexible material or flexible outer material of the upper seal part comprises a thermoplastic vulcanizates, TPV, type material, such as a polymer material selected from the range of Santoprene™ materials, such as Santoprene™ 201-73.

In a possible implementation form of the first aspect or third aspect, the upper seal part has a thickness in the range of 2 to 30 mm, such as in the range of 2 to 20 mm, such as in the range of 2 to 10 mm, such as in the range of 2 to 5 mm, such as in the range of 2.5 to 4 mm, such as about 3 mm.

In a possible implementation form of the first aspect or third aspect, for which the upper seal part is a reinforced flexible seal part, then for the reinforced flexible seal part at least part of or all of said elongated metal members or metal wires are arranged at a distance to each other being no larger than 8 mm, such as no larger than 7 mm, such as no larger than 6 mm, such as no larger than 5 mm, or such as no larger than 4 mm.

In a possible implementation form of the first aspect or third aspect, for which the upper seal part is a reinforced flexible seal part, the spacing between the lower edge of the bottom part of the reinforced flexible seal part and a lowermost positioned metal wire is no larger than 2, such as no larger than 1.5 mm, or such as no larger than 1 mm.

In a possible implementation form of the first aspect or third aspect, for which the upper seal part is a reinforced flexible seal part, then for the reinforced flexible seal part the elongated metal members or metal wires are made of one or more of the following five materials or alloys thereof: a) iron b) steel c) stainless steel, d) spring steel e) welding wire filler metal such as 308 L filler metal.

In a possible implementation form of the first aspect or third aspect, for which the upper seal part is a reinforced flexible seal part, then for the reinforced flexible seal part the elongated metal members or metal wires or metal strips have a thickness or diameter equal to or no less than 0.8 mm, such as equal to or no less than 0.9 mm, such as equal to or no less than 1 mm, or such as equal to or no less than 1.1 mm.

In a possible implementation form of the first aspect or third aspect, for which the upper seal part is a reinforced flexible seal part, then for the reinforced flexible seal part at least part of or all of the elongated metal members of metal wires are metal wires having an a least partly uneven and/or coated outer surface.

The foregoing and other objects are achieved by the features of the independent claims. Further implementation forms are apparent from the dependent claims, the description and the figures. These and other aspects of the invention will be apparent from the embodiments described below.

### BRIEF DESCRIPTION OF THE DRAWINGS

In the following detailed portion of the present disclosure, the invention will be explained in more detail with reference to the example embodiments shown in the drawings, in which:

FIG. 1 is a partially cut away perspective view of a reinforced flexible structure or seal without deformations according to a first example embodiment;

FIG. 2 is a partially cut away perspective view of a reinforced flexible structure or seal without deformations according to a second example embodiment;

FIG. 3 is a perspective view of a reinforced flexible structure or seal without deformations according to an example embodiment;

FIG. 4 is a perspective view of a reinforced flexible structure or seal holding bulging or wavelike deformations according to an example embodiment;

FIG. 5 illustrates a seal combination with a lower seal part holding a brush or fibre material according to a first example embodiment;

FIG. 6 illustrates a lower edge door sealing assembly using the seal combination of FIG. 5 according to an example embodiment;

FIGS. 7a and 7b illustrate a seal combination with a lower seal part holding a brush or fibre material according to a second example embodiment;

FIGS. 8a and 8b illustrate a lower seal part holding a brush or fibre material and provided with hook fasteners according to an example embodiment;

FIGS. 9a and 9b illustrate seal combinations of a flexible structure or seal provided with loop fasteners according to third and fourth example embodiments;

FIG. 10 is an end view of the reinforced flexible structure or seal of FIG. 2;

FIG. 11 illustrates a seal combination of a flexible structure or seal provided with loop fasteners according to a fifth example embodiments;

FIG. 12 illustrates a seal combination of a flexible structure or seal provided with loop fasteners according to a sixth example embodiments;

FIG. 13 illustrates a lower edge door sealing assembly using the seal combination of FIG. 12 according to an example embodiment;

FIG. 14 illustrates a seal combination of a flexible structure or seal and a U-shaped metal rail according to a seventh example embodiments;

FIG. 15 illustrates a lower edge door sealing assembly using the seal combination of FIG. 14 according to an example embodiment; and

FIGS. 16a and 16b illustrate a band having hook fasteners at a front side and a self-adhesive back side.

### DETAILED DESCRIPTION

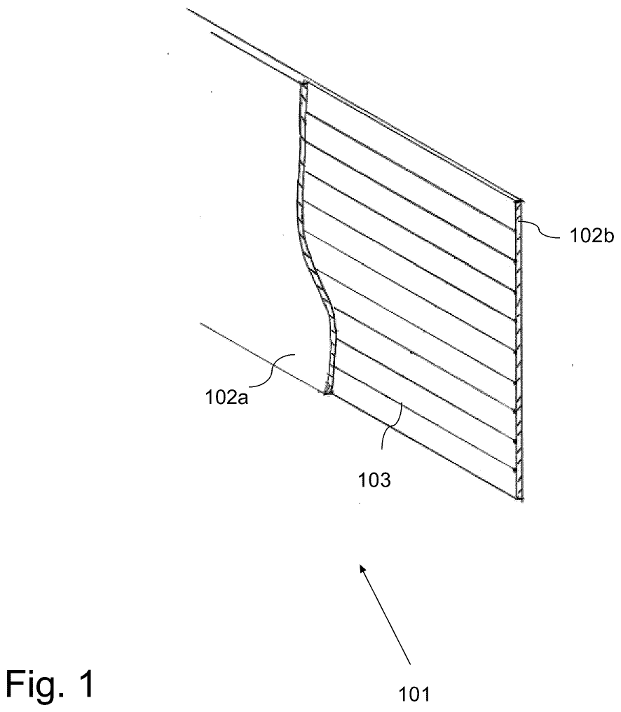

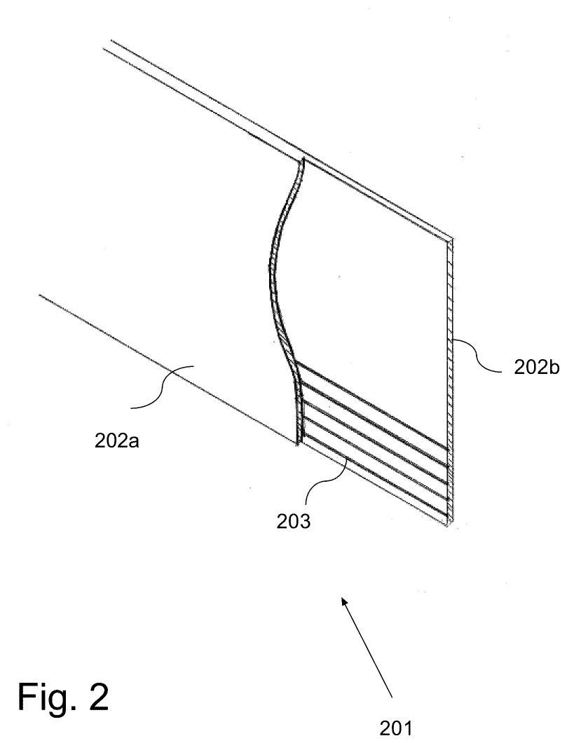

FIG. 1 is a partially cut away perspective view of a reinforced flexible structure or seal 101 without deformations according to a first example embodiment, and FIG. 2 is a partially cut away perspective view of a flexible structure or seal 201 without deformations according to a second example embodiment.

Each of the structures or seals 101 and 201 has a flexible outer material with a first side part 102a, 202a and a second side part 102b, 202b, encompassing or enclosing a plurality of elongated metal members or metal wires 103, 203, where each of the wires 103, 203 run substantially in parallel to each other. The wires 103 and 203 run substantially in parallel to each other. The flexible structure or seal 101 and 201 may have a substantial longitudinal extension, and the elongated metal members or metal wires 103, 203 may run substantially in the longitudinal direction of the structure or seal 101, 201. The substantially parallel elongated metal members or metal wires 103, 203 are arranged at a distance to each other, and it is preferred that the elongated metal members or metal wires 103, 203 are arranged with a substantially equal spacing. It is preferred that the flexible outer material 102a, 102b, 202a, 202b encompasses or encloses the parallel elongated metal members or metal wires 103, 203 only.

The flexible outer material 102a, 102b, 202a, 202b, may have a flattened form with a substantially constant thickness. The flexible outer material 102a, 102b, 202a, 202b may be made of a flexible polymer or plastic material, such as flexible polyvinyl chloride, PVC, and/or a flexible rubber material, and may have a thickness in the range of 2 to 30 mm, such as in the range of 2 to 20 mm, such as in the range of 2 to 10 mm, such as in the range of 2 to 5 mm, such as in the range of 2.5 to 4 mm, such as about 3 mm.

In order to use the structures or seals 101, 201 the wires may be dimensioned and made of a material, which rats and/or mice cannot bite them a way through. Thus, the wires shall have a thickness and be made of a material, which the rats and/or mice cannot bite through, and also the distance between the wires shall be so small, that the rats and/or mice cannot move in between the wires.

The wires 103, 203 may therefore be arranged at a distance to each other which is no larger than 20 mm, such as no larger than 19 mm, such as no larger than 18 mm, such as no larger than 17 mm, such as no larger than 15 mm, such as no larger than 12 mm, such as no larger than 10 mm, such as no larger than 9 mm, such as no larger than 8 mm, such as no larger than 7 mm, such as no larger than 6 mm, such as no larger than 5 mm, such as no larger than 4 mm, such as no larger than 3 mm, or such as no larger than 2 mm. Here, it is preferred that the distance between the wires 103, 203 is equal to or no larger than 8 mm, equal to or no larger than 7 mm, equal to or no larger than 6 mm, equal to or no larger than 5 mm, or equal to or no larger than 4 mm.

The wires 103, 203 may be made of steel or stainless steel or spring steel, or the wires may be made of iron. The wires 103, 203 may also be made as flexible metal wires, such as braided or twisted wires. The metal wires 103, 203 can also be formed as narrow metal strips having a width, which may be substantially equal to the thickness of the narrow metal strips, or in the range of one to two or three times the thickness of the narrow metal strips.

The wires or thin metal strips 103, 203 may have a thickness or diameter equal to or no less than 0.4 mm, equal to or no less than 0.6 mm, equal to or no less than 0.7 mm, equal to or no less than 0.8 mm, equal to or no less than 0.9 mm, equal to or no less than 1 mm, equal to or no less than 1.1 mm, equal to or no less than 1.2 mm, equal to or no less than 1.2 mm, equal to or no less than 1.3 mm, equal to or no less than 1.4 mm, equal to or no less than 1.5 mm, equal to or no less than 1.6 mm, equal to or no less than 1.7 mm, equal to or no less than 1.8 mm, equal to or no less than 1.9 mm, equal to or no less than 2.0 mm, equal to or no less than 2, 1 mm, equal to or no less than 2.2 mm, equal to or no less than 2.4 mm, equal to or no less than 2.7 mm, or equal to or no less than 3 mm.

When the wires 103, 203 are formed as metal strips, the metal strips may have a width equal to or no less than 1 mm, equal to or no less than 1.5 mm, equal to or no less than 2 mm, or equal to or no less than 2.5 mm.

The flexible structure 101, 201 may have different widths, but when used for sealing, the structure 101, 201 may have a width in the range of 1.5 to 30 cm, such as in the range of 2 to 25 cm, such as in the range of 2 to 20 cm, such as in the range of 2 to 15 cm, such as in the range of 4 to 10 cm, such as in the range of 5 to 9 cm, such as about 8 cm or 7.5 cm.

By having the metal wires 103, 203 running substantially in parallel, the structure 101, 201 can bend or flex about an axis being substantially parallel to the metal wires 103, 203, whereas bending or flexing of the structure 101, 201 about an axis perpendicular to the parallel metal wires 103, 203 will be rather limited due to the stiffness of the metal wires 103, 203.

The structure or seal 201 of FIG. 2 is substantially equal to the structure or seal 101 of FIG. 1, but some metal wires 203 may be omitted in the upper part of the structure 201.

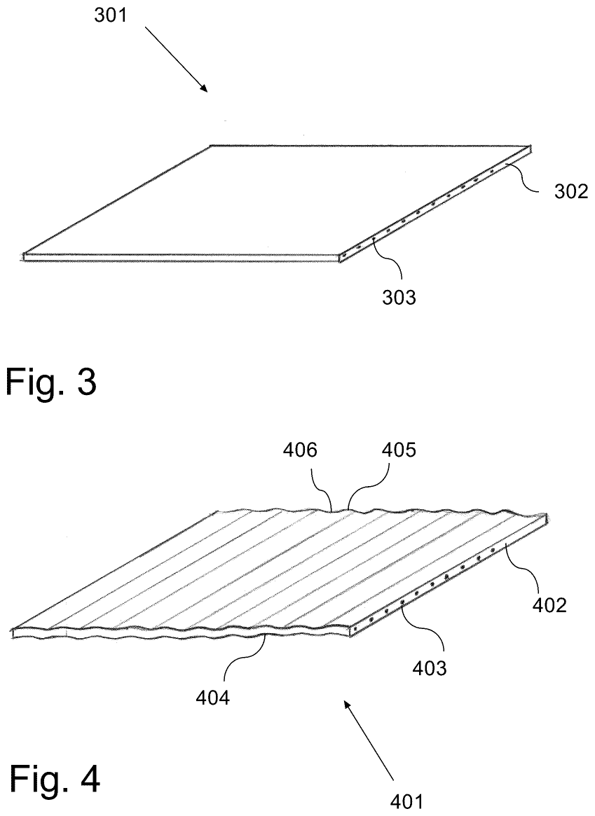

One of the problems with the structures 101 and 201 is that when the structure 101, 201, is used for example as a seal or barrier at the bottom of a door or at and edge of a door leaf, the opening and closing of the door may bend the lower part of the structure 101, 201 back and forth along an axis substantial parallel to the metal wires 103, 203, which bending may cause the metal wires 103, 203 to move relative to the flexible outer material 102, 202. The result may be that for an end part of the structure 101, 201, part of the metal wires 103, 203 may extend outside the end part of the flexible outer material 102, 202. A solution to this problem may be to provide deformations along the metal wires 103, 203 being embedded or enclosed in the flexible outer material 102, 202. This is further illustrated in FIGS. 3 and 4.

FIG. 3 is a perspective view of a reinforced flexible structure or seal 301 without deformations. The seal 301 may be equal to any of the above discussed seals 101 and 201, and thus has a flexible outer material 302 encompassing or enclosing a plurality of elongated metal members or metal wires 303, where the wires 303 run substantially in parallel to each other. There may be metal wires 303 in the whole width of the seal 301, as for the seal 101, or there may be metal wires 303 in only a part of the width of the seal as for the seal 201.

The seals 101, 201 and 301 may be produced by an extrusion process.

FIG. 4 is a perspective view of a reinforced flexible structure or seal 401 similar to the seal 301, but where the seal 401 is provided with bent, bulging or wavelike deformations 404. The seal has a flexible outer material 402 encompassing or enclosing a plurality of elongated metal members or metal wires 403, where the wires 403 run substantially in parallel to each other.

For the seal 401, the embedded elongated metal wires 403 hold several bent, bulging or wavelike deformations 404 in the longitudinal direction of the wires 403. Due to the deformations 404 of the metal wires 403, the flexible outer material 402 enclosing the metal wires 403 and thereby the outer surfaces of the reinforced flexible seal 401 are deformed accordingly. The metal wires 403 holding the wavelike deformations 404 in the longitudinal direction, run substantially parallel to each other. Thus, the bent, bulging or wavelike deformations 404 extend substantially perpendicular to a plane defined by the lengthwise and widthwise directions of the reinforced flexible seal 401 as illustrated in FIG. 4.

By having the metal wires 403 deformed by several bent, bulging or wavelike deformations 404 while being embedded within the flexible outer material 402, the metal wires 403 will be locked within the flexible material 402, and the elongated metal wires 403b may not be able to move relative to the flexible material 402, if the flexible seal 401 is flexed back and forth relative to a lengthwise direction of the elongated metal wires 403 and the flexible seal 401. When the metal wires 403 are held in position within the seal 401, the reinforcement of the seal 401 is maintained during use.

The bent, bulging or wavelike deformations 404 may be bends or stable bends, which may include bent deformations, curve-shaped bends, and/or wave-shaped bends.

For the seal 401 of FIG. 4, all the deformations, bends, or wavelike deformations 404 are provided for all the wires 403 extending within the seal 401. However, if a part of the seal 401 is used for connection to a door leaf of door wing, any wires 403 extending within such a connection part may not be deformed, since such a connection part will not be flexed during opening and closing of the door leaf or door wing holding the seal 401.

For the seal 401, the flexible outer material 402 may have a thickness in the range of 2 to 30 mm, such as in the range of 2 to 20 mm, such as in the range of 2 to 10 mm, such as in the range of 2 to 5 mm, such as in the range of 2.5 to 4 mm, such as about 3 mm. The thickness may be substantially constant.

For the seals 401, the flexible outer material 402 may be made of a plastic material or flexible polymer material. The flexible outer material 402 may be a material comprising a natural polymer material such as rubber and/or a synthetic polymer material such as synthetic rubber. The flexible outer material 402a, 402b may be a material comprising a thermoplastic elastomer, TPE, material, a thermoplastic vulcanizates, TPV, type material or a polyvinyl chloride, PVC, material. The flexible outer material 402 may have a shore hardness, Shore A, of not below 40, such as not below 50, such as not below 60, such as not below 65, such as not below 70, such as not below 75, such as in the range of 75-80. For some purposes, even harder material may be used having a shore hardness, Shore A, of not below 80, such as not below 85, such as not below 90.

The flexible outer material 402a, 402b may be a polymer material is selected from the range of Santoprene™ materials, such as Santoprene™ 201-73.

Also, for the seals 401, the wires 403 should preferably have a thickness and be made of a material, which the rats and/or mice cannot bite through, and also the distance between the wires shall be so small, that the rats and/or mice cannot move in between the wires. It is within a preferred embodiment that for at least part of or all of said plurality of elongated metal wires 403, the distance between two neighbouring wires does not exceed a predetermined maximum distance. The reinforced flexible seal 401 has a lower or outer edge, and it is preferred that the spacing between said lower or outer edge and a lower- or outermost positioned elongated metal wire is smaller than said predetermined maximum distance. It is within a preferred embodiment that the bulging or wavelike deformations in the longitudinal direction of a wire are arranged with substantially equal spacing. The reinforced flexible seal 401 has a lower or outer edge, and the spacing between said lower or outer edge and a lower- or outermost positioned elongated metal wire should preferably be smaller than said substantially equal spacing.

The wires 403 may be arranged at a distance to each other which is no larger than 12 mm, such as no larger than 10 mm, such as no larger than 9 mm, such as no larger than 8 mm, such as no larger than 7 mm, such as no larger than 6 mm, such as no larger than 5 mm, such as no larger than 4 mm, such as no larger than 3 mm, or such as no larger than 2 mm. Here, it is preferred that the distance between the wires 403a or 403b is equal to or no larger than 8 mm, equal to or no larger than 7 mm, equal to or no larger than 6 mm, equal to or no larger than 5 mm, or equal to or no larger than 4 mm.

The wires 403 may be made of steel or stainless steel or spring steel, or the wires may be made of iron. The wires 403 may also be made as flexible metal wires, such as braided or twisted wires. The metal wires 403 can also be formed as narrow metal strips having a width, which may be substantially equal to the thickness of the narrow metal strips, or in the range of one to two or three times the thickness of the narrow metal strips. The wires or thin metal strips 403 may have a thickness or diameter equal to or no less than 0.4 mm, equal to or no less than 0.6 mm, equal to or no less than 0.7 mm, equal to or no less than 0.8 mm, equal to or no less than 0.9 mm, equal to or no less than 1 mm, equal to or no less than 1.1 mm, equal to or no less than 1.2 mm, equal to or no less than 1.2 mm, equal to or no less than 1.3 mm, equal to or no less than 1.4 mm, equal to or no less than 1.5 mm, equal to or no less than 1.6 mm, equal to or no less than 1.7 mm, equal to or no less than 1.8 mm, equal to or no less than 1.9 mm, equal to or no less than 2.0 mm, equal to or no less than 2.1 mm, equal to or no less than 2.2 mm, equal to or no less than 2.4 mm, equal to or no less than 2.7 mm, or equal to or no less than 3 mm. When the wires 403 are formed as metal strips, the metal strips may have a width equal to or no less than 1 mm, equal to or no less than 1.5 mm, equal to or no less than 2 mm, or equal to or no less than 2.5 mm.

The flexible structure 403 may have different widths, but when used for sealing, the structure 403 may have a width in the range of 1.5 to 30 cm, such as in the range of 2 to 25 cm, such as in the range of 2 to 20 cm, such as in the range of 2 to 15 cm, such as in the range of 4 to 10 cm, such as in the range of 5 to 9 cm, such as about 8 cm or 7.5 cm.

The seal 401 of FIG. 4 may be obtained by first producing the seal 301 of FIG. 3, which can be produced by an extrusion process, and then expose the seal 301 to a further process for forming the wavelike deformations 404.

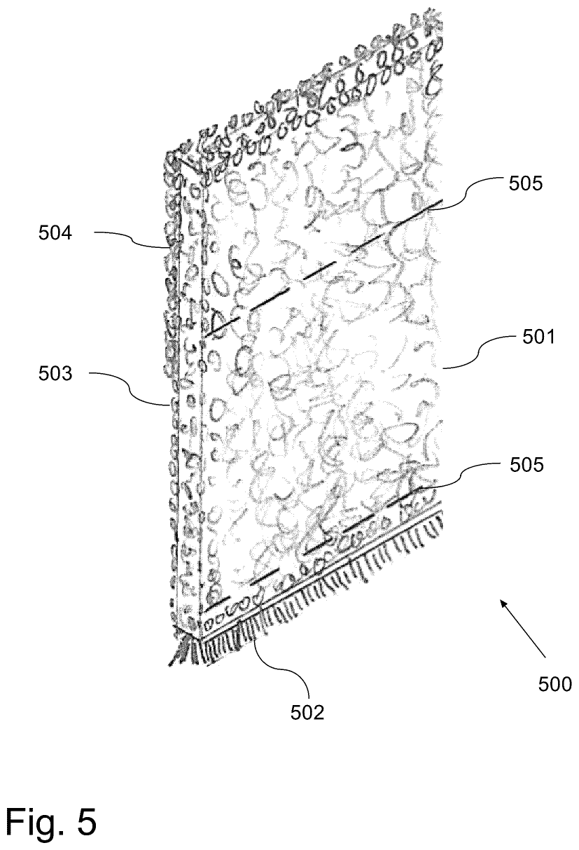

FIG. 5 shows a seal combination 500 with a lower seal part holding a brush or fibre material 502 according to a first example embodiment. The seal combination 500 comprising an upper seal part 501, which may be formed at least partly by a flexible seal made of a flexible material, and a lower seal part holding a brush or fibre material 502. The upper seal part 501 may hold a reinforced flexible structure or seal 101, 201, 301 or 401 as described in connection with FIGS. 1, 2, 3 and 4, but the upper seal part 501 may also hold a flexible seal made of the same flexible material as used for the seal 101 but without any metal wires 103. The upper seal part 501 has a length, a width and a maximum thickness, first and second outer sidewalls, a bottom part and a top part, and extends in a longitudinal direction. For the seal combination 500 of FIG. 5, the flexible seal upper seal part 501 is fully covered by a flexible fabric or web like sheet 503 provided with loop fasteners, where the flexible fabric or web like sheet 503 is secured to the upper seal part 501 and bent around the bottom part of the upper seal part 501 with the loop fasteners facing outwards from the upper seal part.

For the seal combination 500 of FIG. 5, the whole surface of both the first and second outer sidewalls of the upper seal part 501 is provided with loop fasteners by the flexible fabric or web like sheet 503. Furthermore, an upper side part of the upper seal part 501 is covered by a double layer 504 of the flexible fabric or web like sheet with loop fasteners. However, it is also within embodiments that only part of the upper seal part 501 is covered by the flexible fabric or web like sheet 503 holding loop fasteners, as long as the bottom part of the upper seal part 501 is provided with loop fasteners facing outwards from the upper seal part 501. Thus, it is within embodiments that at one half or at least one half, such as two thirds or least two thirds of the surface of the first and/or second outer sidewall of the upper seal part 501 is provided with loop fasteners. It is also within an embodiment that only one of the surfaces of the first and/or second outer sidewall of the upper seal part 501 is provided with loop fasteners.

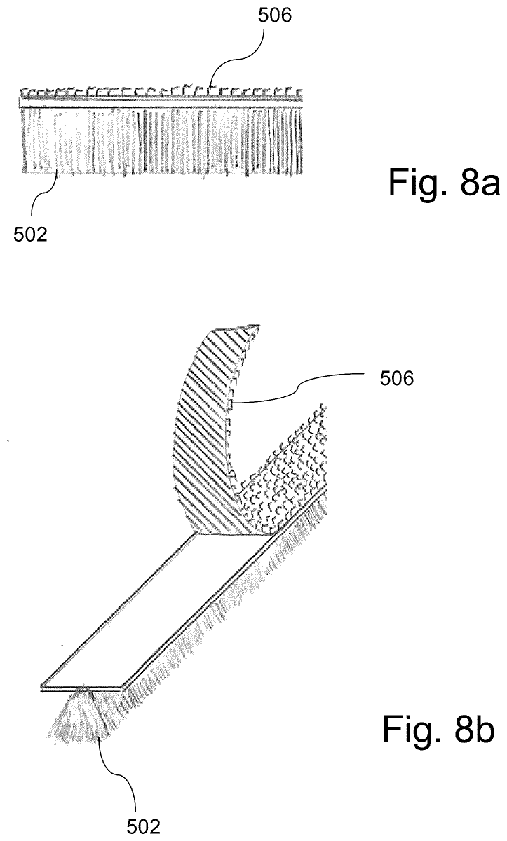

For the seal combination 500 of FIG. 5, the lower seal part has a top part releasably secured to the bottom part of the upper seal part 501 and extends in the longitudinal direction of the upper seal part along said bottom part. The top part of lower seal part is provided with a strip of hook fasteners 506, see FIGS. 8a and 8b, and the bottom part of the upper seal part 501 is provided with loop fasteners mating with the strip of hook fasteners 506 provided at the lower seal part to thereby releasably secure the lower seal part to the upper seal part.

For the seal combination 500 of FIG. 5, the length of brush or fibre material 502 of the lower seal part may be smaller than or equal to ¼, ⅕ or ⅙ of the width of the upper seal part. Also, the top part of the lower seal part may have a width, which is substantially equal to or no larger than the maximum thickness of the upper seal part 501.

For the seal combination 500 shown in FIG. 5, the upper seal part 501 holds loop fasteners and the lower seal part has a top part holding hook fasteners 506. However, it should be understood that the present disclosure also comprises embodiments of seal combinations being similar to the above described embodiments for the seal combination 500, but for which embodiments the upper seal part is provided with hook fasteners and the top part of the lower seal part is provided with loop fasteners, to thereby releasably secure the lower seal part to the upper seal part.

The flexible fabric or web like sheet 503 holding loop or hook fasteners may be secured to the upper seal part 501 by use of an adhesive or by use of tape, such as double sided tape, where the flexible fabric or web like sheet may be secured to one side of the tape. Alternatively, or additional, the flexible fabric or web like sheet 503 holding loop or hook fasteners may be secured to the upper seal part 501 by sewing as indicated by dotted lines 505 in FIG. 1. Also for the top part of the lower seal part, the strip of hook or loop fasteners 506 may be secured to the top part of the lower seal part by use of an adhesive or by use of tape, such a double-sided tape, where the strip of hook or loop fasteners 506 may be secured to one side of the tape. Alternatively, or additional, the strip of hook or loop fasteners 506 may be sewed to the top part of the lower seal part.

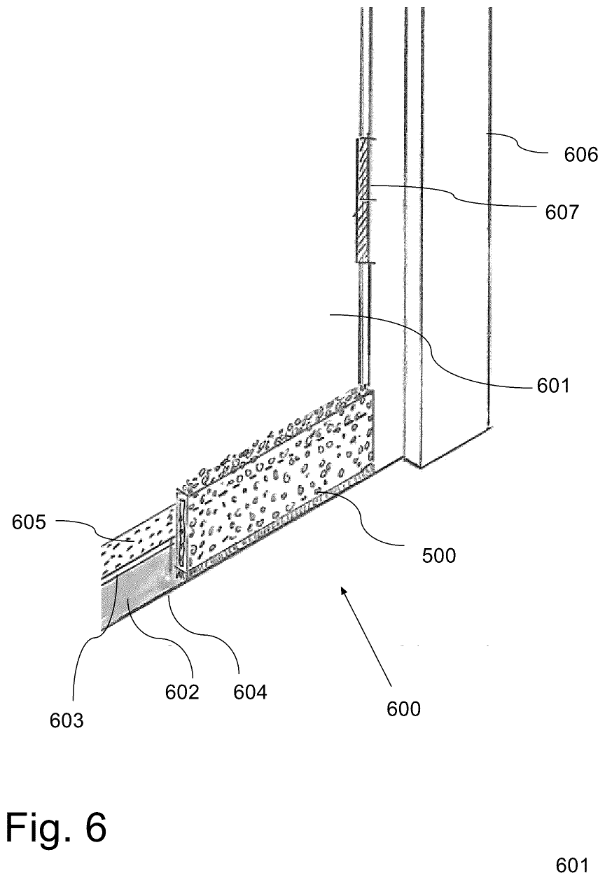

FIG. 6 illustrates a lower edge door sealing assembly 600 using the seal combination 500 of FIG. 5 according to an example embodiment. The assembly 600 comprises a door or door wing 601 attached to a door frame 606 with a hinge 607, where the door or door wing 601 has an outer edge part 603, with a gap 602 provided between the outer edge part 601 and a floor or ground surface 604. The outer edge part 603 of the door 601 is provided with hook fasteners by a flexible fabric or web like sheet 605 holding hooks, where the flexible fabric or web like sheet 605 is secured to the outer edge part 603 with the hook fasteners facing outwards from the outer edge part 603. The flexible fabric or web like sheet 605 may be secured to the outer edge part 603 by an adhesive, such as by taping. The upper part of the seal combination 500 is releasably secured to the outer edge part 603 of the door or door wing 601 with the loop fasteners 503 provided at the first or second sidewall of the upper seal part 501 mating with the hook fasteners 605 provided at the outer edge part 603 of the door or door wing 601. The seal combination 500 is secured to the outer edge part 603 of the door or door wing 601 with the bottom part of the upper seal part 501 and the lower seal part holding the brush or fibre material 502 extending below the outer edge part 603 of the door 601, to thereby seal the gap 602 between the outer edge part 601 and the floor or ground surface 604.

For seal combinations similar to the combination 500, but for which the flexible fabric or web like sheet 503 is provided with hook fasteners instead of loop fasteners, the flexible fabric or sheet 605 shall be provided with loop fasteners instead of hook fasteners.

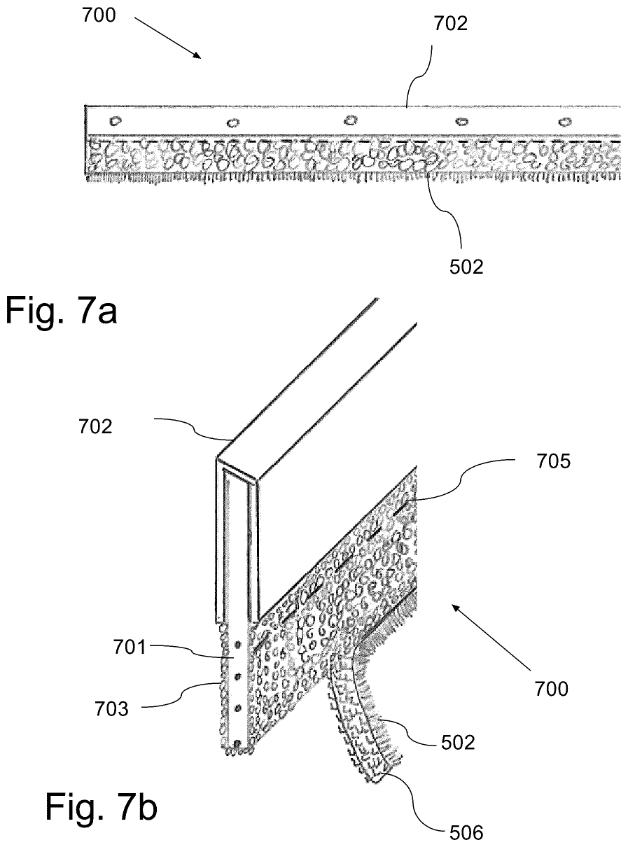

FIGS. 7a and 7b illustrate a seal combination 700 with a lower seal part holding a brush or fibre material 502 according to a second example embodiment. The seal combination 700 may be equal to or of the same type as the seal combination 500 of FIG. 5. Thus, the seal combination 700 has an upper seal part 701 formed at least partly by a flexible material and a lower seal part holding a brush or fibre material 502. The upper seal part 701 may be a reinforced flexible seal part comprising a flexible outer material, and a plurality of elongated metal wires embedded in the flexible outer material and running substantially in a longitudinal direction of the reinforced flexible. The lower seal part has a top part provided with a strip of hook fasteners 506, and the bottom part of the upper seal part 701 is provided with loop fasteners mating with the strip of hook fasteners 506 provided at the lower seal part to thereby releasably secure the lower seal part to the upper seal part 701.

For the seal combination 700 there is no need of having the top part of the upper seal part 701 provided by loop or hook fasteners. Thus, as illustrated in FIG. 7b the bottom part and lower sidewall parts of the upper seal part 701 may be provided with loop fasteners by a flexible fabric or web like sheet 703 holding loop fasteners. The flexible fabric or web like sheet 703 may be secured to the upper seal part 701 by an adhesive, by tape, or may be sewed to the upper seal part 701, as illustrated by dotted line 705.

The seal combination 700 of FIGS. 7a and 7b holds a substantially U-shaped metal rail 702 having a length, a bottom wall, and first and second sidewalls. The U-shaped rail 702 is arranged at the upper seal part 701 with the bottom wall covering the top part of the upper seal part 701, the first sidewall covering a part of the first outer sidewall of the upper seal part 701, and the second sidewall covering a part of the second outer sidewall of the upper seal part 701. Here, at least one third of the surface of the first and second outer sidewalls of the upper seal part may be covered by the sidewalls of said metal rail. The metal rail 702 may be provided with screw holes, whereby the seal combination 700 may be secured to a door edge by screws going through the screw holes, whereby the upper seal part 701 is also secured to the metal rail 702. The metal rail 702 may for example be made in aluminium, steel or stainless steel.

FIGS. 8a and 8b illustrate a lower seal part of the type used for the seal combinations 500 and 700 of FIGS. 5 and 7a and 7b. The lower seal part holds a brush or fibre material 502 and has a top part provided with a strip of hook fasteners 506. The strip of hook fasteners 506 may be secured to the top part of the lower seal part by use of an adhesive or by use of tape, such a double-sided tape, where the strip of hook fasteners 506 may be secured to one side of the tape. For embodiments where the lower seal part shall be provided with loop fasteners, the strip 506 may be a strip of loop fasteners.

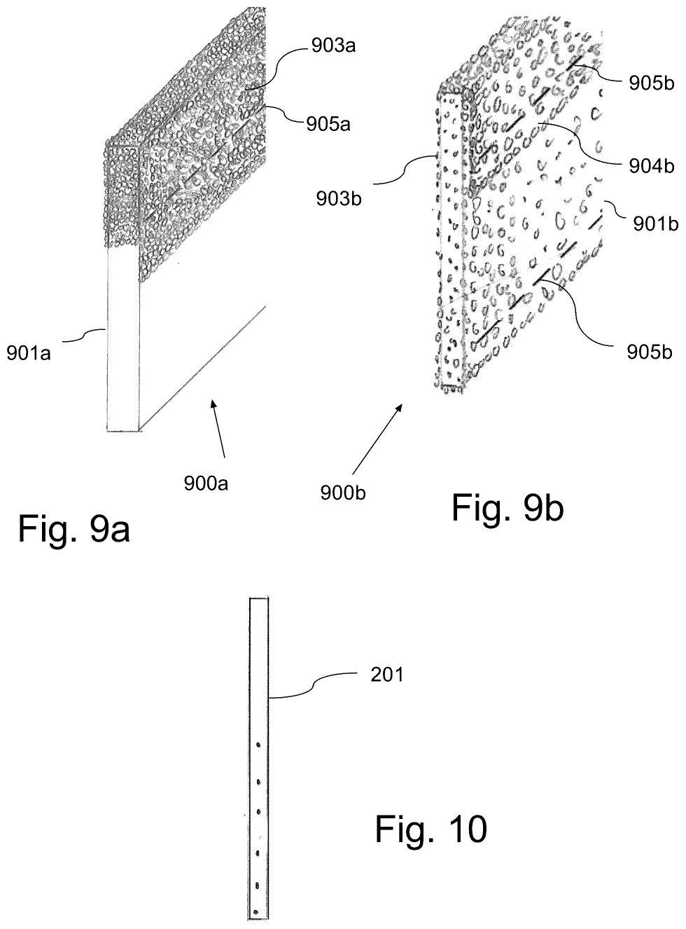

FIGS. 9a and 9b illustrate seal combinations 900a, 900b of a flexible structure or seal 901a, 901b provided with loop fasteners according to third and fourth example embodiments. The flexible structure or seal 901a, 901b may be a reinforced flexible structure or seal 101, 201, 301 or 401 as described in connection with FIGS. 1, 2, 3 and 4, but the flexible structure or seal 901a, 901b may also be a flexible seal made of the same flexible material as used for the seal 101 but without any metal wires 103. The flexible structure or seal 901a, 901b has a length, a width and a maximum thickness, first and second outer sidewalls, a bottom part and a top part, and extends in a longitudinal direction. The flexible structure or seal 901a has an upper part covered on both sides by a flexible fabric or web like sheet 903a provided with loop fasteners, where the flexible fabric or web like sheet 903a is secured to the upper part and bent around the top part with the loop fasteners facing outwards from the upper part. The flexible fabric or web like sheet 903a may be secured to the structure or seal 901a by sewing as indicated by dotted line 905a in FIG. 9a. The flexible structure or seal 901b is fully covered on both sides by a flexible fabric or web like sheet 903b provided with loop fasteners, where the flexible fabric or web like sheet 903b is bent around both the top and bottom parts with the loop fasteners facing outwards from the structure or seal 901b. The flexible fabric or web like sheet 903b may be secured to the structure or seal 901a by sewing as indicated by dotted lines 905b in FIG. 9b. For the seal combination 900b, an upper side part of the structure or seal 900b is covered by a double layer 904b of the flexible fabric or web like sheet 903b with loop fasteners.

The seal combinations 900a and 900b of FIGS. 9a and 9b, are partly or fully covered by a flexible fabric or web like sheet 903a, 903 provided with loop fasteners. However, it should be understood that the present disclosure also comprises embodiments of seal combinations being similar to the above described embodiments for the seal combinations 901a and 901b, but for which embodiments the flexible fabric or web like sheet 903a, 903b is provided with hook fasteners instead of loop fasteners.

Any of the seal combinations 900a and 900b may be used in sealing assemblies for sealing a gap or space between an outer edge of a wall, fence, door, sliding door, port or window and a surface adjacent to the wall, fence, door, sliding door, port or window. This is especially for the cases, where a lower seal part holding brush or fibre materials are not needed. Thus, any of the seal combinations 900a and 900b may be used to replace the seal combination 500 in the lower edge door sealing assembly 600 of FIG. 6, whereby the seal combination 900a or 900b may be releasably secured to the outer edge part 603 of the door 601 with the loop fasteners 903a or 903b mating with the hook fasteners 605 provided at the outer edge part 603 of the door 601. For seal combinations similar to the combinations 900a and 900b, but for which the flexible fabric or web like sheet 903a, 903b is provided with hook fasteners instead of loop fasteners, the flexible fabric or sheet 605 shall be provided with loop fasteners instead of hook fasteners.

FIG. 10 is an end view of the reinforced flexible structure or seal of FIG. 2, which may be used for the seal combinations 900a and 900b of FIGS. 9a and 9b.

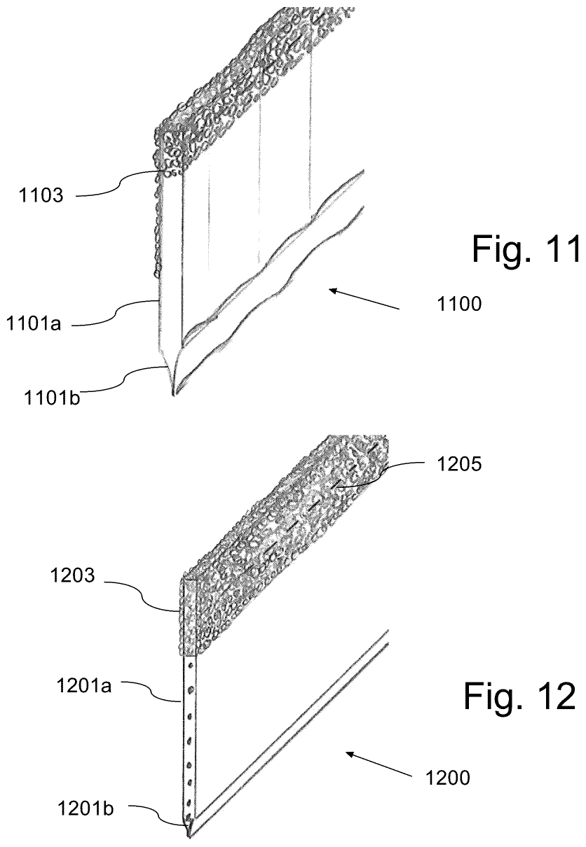

FIGS. 11 and 12 illustrate seal combinations 1100 and 1200 of flexible structures or seals provided with loop fasteners according to fifth and sixth example embodiments. Each of the seal combinations 1100 and 1200 holds a seal comprising an upper seal part 1101a, 1201a formed at least partly by a flexible material and a lower seal part 1101b, 1201b formed by the same flexible material. The upper seal part 1101a, 1201a has a length, a width and a maximum thickness, first and second outer sidewalls, a bottom part and a top part, and extends in a longitudinal direction. The lower seal part 1101b, 1201b has a length, a width being smaller than the width of the upper seal part 1101a, 1201a and a lower edge with an edge-thickness which is smaller than the maximum thickness of the upper seal part, where the edge-thickness is smaller than or equal to ½, ⅓, ¼ or ⅕ of the maximum thickness of the upper seal part 1101a, 1201a. The lower seal part 1101b, 1201b may have a thickness, which decreases along the width of the lower seal part 1201a, 1201b from a connection point between the upper seal part 1101a, 1201a and the lower seal part towards the lower edge of the lower seal part 1101b, 1201b. For each of the seal combinations 1100 and 1200, the upper seal part 1101a, 1201a and the lower seal part 1101b, 1201b may be made in one piece, which may be made by extrusion, and the length of the lower seal part 1101b, 1201b may be substantially equal to the length of the upper seal part 1101a, 1201a. The width of the lower seal part 1101b, 1201b may be smaller than or equal to ¼, ⅕ or ⅙ of the width of the upper seal part 1101a, 1201a.

For the seal combination 1200, the upper seal part 1201a is a reinforced flexible seal part comprising a flexible outer material, a plurality of elongated metal wires embedded in the flexible outer material and running substantially in a longitudinal direction of the reinforced flexible seal part with at least part of said elongated metal wires arranged at a distance to each other. Thus, the upper seal part 1201a may be a reinforced flexible structure or seal part similar to the reinforced flexible structure or seal 101, 201, 301 or 401 as described in connection with FIGS. 1, 2, 3 and 4.

For the seal combination 1100, the upper seal part 1101a is a flexible seal part, which may be made of the same flexible material as used for the seal 101 but without any metal wires 103.

For each of the seal combinations 1100 and 1200 shown in FIGS. 11 and 12, the upper seal part 1101a, 1201a is partly provided with loop fasteners by a flexible fabric or web like sheet 1103, 1203 holding loop fasteners and secured to the upper seal part with the loop fasteners facing outwards from the upper seal part. It is preferred that at least one third, or at least one half, or such as at least two thirds of the surface of the first and/or second outer sidewall of the upper seal part 1101a, 1201a is provided with loop fasteners by said flexible fabric or web like sheet. It is also preferred that the flexible fabric or sheet 1103, 1203 is bent around the top part of the upper seal part 1101a, 1201a with the loop fasteners facing outwards from the upper seal part. The flexible fabric or web like sheet 1103, 1203 may be secured to the upper seal part 1101a, 1201a by sewing as indicated by dotted line 1205 in FIG. 12. Alternatively, or additional, the flexible fabric or web like sheet 1103, 1203 may be secured to the upper seal part 1101a, 1201a by an adhesive, such as by taping.

The seal combinations 1100 and 1200 of FIGS. 11 and 12, are partly covered by a flexible fabric or web like sheet 1103, 1203 provided with loop fasteners. However, it should be understood that the present disclosure also comprises embodiments of seal combinations being similar to the above described embodiments for the seal combinations 1100 and 1200, but for which embodiments the flexible fabric or web like sheet 1103, 1203 is provided with hook fasteners instead of loop fasteners.

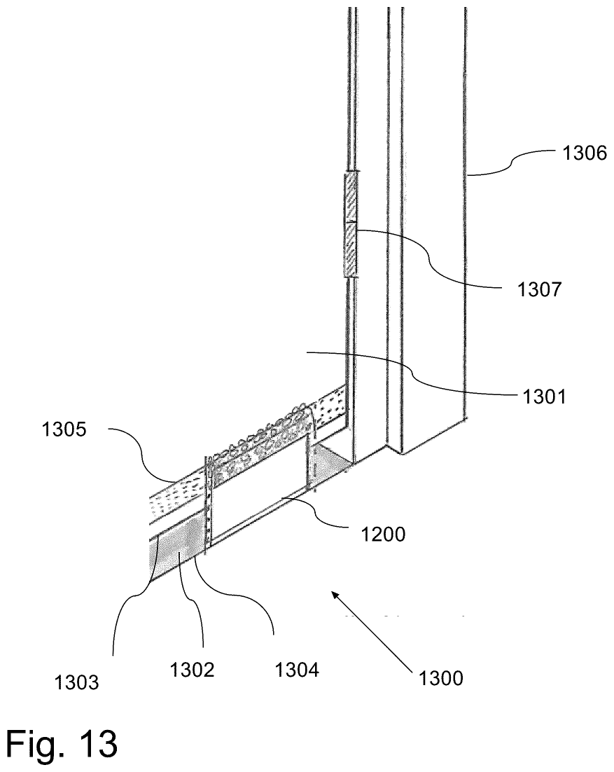

FIG. 13 illustrates a lower edge door sealing assembly 1300 using the seal combination 1200 of FIG. 12 according to an example embodiment. The assembly 1300 comprises a door or door wing 1301 attached to a door frame 1306 with a hinge 1307, where the door or door wing 1301 has an outer edge part 1303, with a gap 1302 provided between the outer edge part 1301 and a floor or ground surface 1304. The outer edge part 1303 of the door or door wing 1301 is provided with hook fasteners by a flexible fabric or web like sheet 1305 holding hooks, where the flexible fabric or web like sheet 1305 is secured to the outer edge part 1303 with the hook fasteners facing outwards from the outer edge part 13103. The flexible fabric or web like sheet 1305 may be secured to the outer edge part 1303 by an adhesive, such as by taping. The upper part of the seal combination 1200 is releasably secured to the outer edge part 1303 of the door or door wing 1301 with the loop fasteners 1203 provided at the first or second sidewall of the upper seal part 1201 mating with the hook fasteners 1305 provided at the outer edge part 1303 of the door or door wing 1301. The seal combination 1200 is secured to the outer edge part 1303 of the door or door wing 1301 with the bottom part of the upper seal part 1201a and the lower seal part 1201b extending below the outer edge part 1303 of the door or door wing 1301, to thereby seal the gap 1302 between the outer edge part 1303 and the floor or ground surface 1304.

For seal combinations similar to the combination 1200, but for which the flexible fabric or web like sheet 1203 is provided with hook fasteners instead of loop fasteners, the flexible fabric or sheet 1305 shall be provided with loop fasteners instead of hook fasteners.

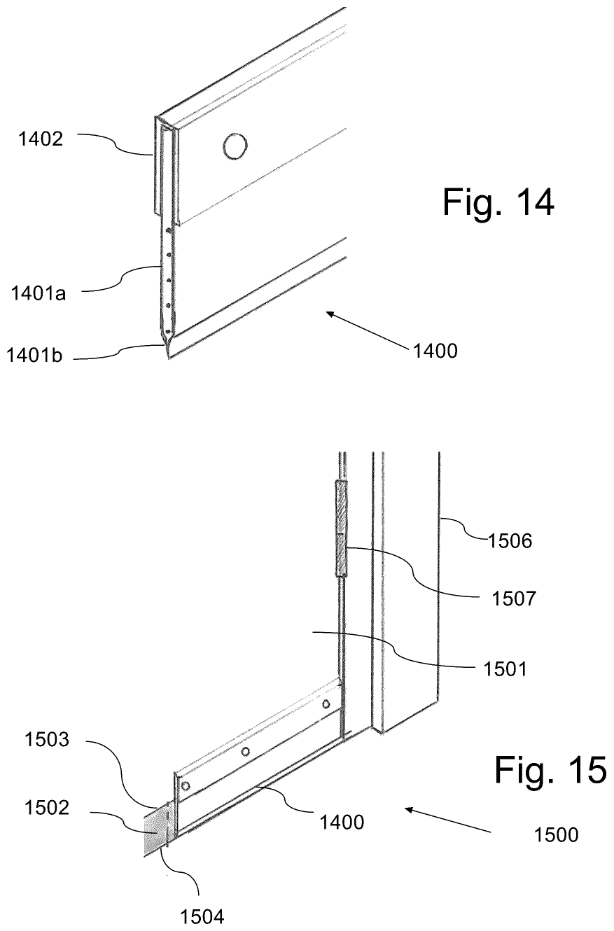

FIG. 14 illustrates a seal combination 1400 of a flexible structure or seal and a U-shaped metal rail 1402 according to a seventh example embodiments. The flexible structure or seal of the seal combination 1400 comprises an upper seal part 1401a formed at least partly by a flexible material and a lower seal part 1401b formed by the same flexible material. The upper seal part 1401a has a length, a width and a maximum thickness, first and second outer sidewalls, a bottom part and a top part, and extends in a longitudinal direction. The lower seal part 1401b has a length, a width being smaller than the width of the upper seal part 1401a and a lower edge with an edge-thickness which is smaller than the maximum thickness of the upper seal part, where the edge-thickness is smaller than or equal to ½, ⅓, ¼ or ⅕ of the maximum thickness of the upper seal part 1401a. The lower seal part 1401b may have a thickness, which decreases along the width of the lower seal part 1401b from a connection point between the upper seal part 1401a and the lower seal part towards the lower edge of the lower seal part 1401. The upper seal part 1401a and the lower seal part 1401b may be made in one piece, which may be made by extrusion, and the length of the lower seal part 1401b may be substantially equal to the length of the upper seal part 1401a. The width of the lower seal part 1401b may be smaller than or equal to ¼, ⅕ or ⅙ of the width of the upper seal part 1401a.

For the seal combination 1400, the upper seal part 1401a is a reinforced flexible seal part comprising a flexible outer material, a plurality of elongated metal wires embedded in the flexible outer material and running substantially in a longitudinal direction of the reinforced flexible seal part with at least part of said elongated metal wires arranged at a distance to each other. Thus, the upper seal part 1401a may be a reinforced flexible structure or seal part similar to the reinforced flexible structure or seal 101, 201, 301 or 401 as described in connection with FIGS. 1, 2, 3 and 4.

The seal combination 1400 of FIG. 14 holds a substantially U-shaped metal rail 1402 having a length, a bottom wall, and first and second sidewalls. The U-shaped rail 1402 is arranged at the upper seal part 1401a with the bottom wall covering the top part of the upper seal part 1401a, the first sidewall covering a part of the first outer sidewall of the upper seal part 1401a, and the second sidewall covering a part of the second outer sidewall of the upper seal part 1401a. Here, at least one third of the surface of the first and second outer sidewalls of the upper seal part may be covered by the sidewalls of said metal rail. The metal rail 1402 may be provide with screw holes, whereby the seal combination 1400 may be secured to a door edge by screws going through the screw holes, whereby the upper seal part 1401a is also secured to the metal rail 1402. The metal rail 1402 may for example be made in aluminium, steel or stainless steel.

FIG. 15 illustrates a lower edge door sealing assembly 1500 using the seal combination 1400 of FIG. 14 according to an example embodiment. The assembly 1500 comprises a door or door wing 1501 attached to a door frame 1506 with a hinge 1507, where the door or door wing 1501 has an outer edge part 1503, with a gap 1502 provided between the outer edge part 1501 and a floor or ground surface 1504. The seal combination 1400 is secured to the outer edge part 1503 of the door or door wing 1501 with the bottom part of the upper seal part 1401a and the lower seal part 1401b extending below the outer edge part 1503 of the door or door wing 1501, to thereby seal the gap 1502 between the outer edge part 1503 and the floor or ground surface 1504.

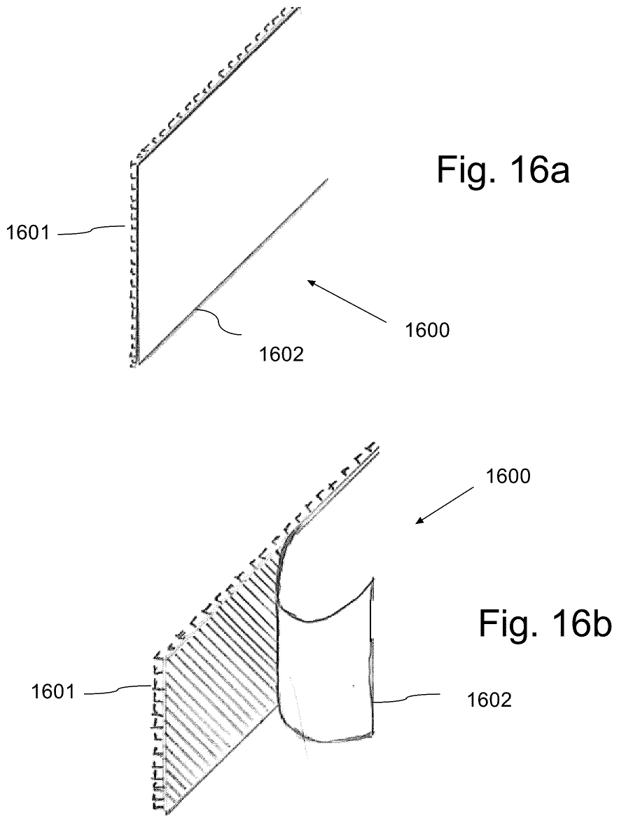

FIGS. 16a and 16b illustrate a commercially available flexible fabric or web like sheet or band 1600 having hook fasteners 1601 at a front side and a self-adhesive back side. In FIG. 16a the back side is covered by a protective sheet layer 1602, which can be a paper or plastic sheet, and in FIG. 16b the protective sheet layer 1602 is removed to uncover the self-adhesive back side. The hook sheet or band 1600 may be made of a plastic material such as nylon.

This type of band or sheet 1600 may be used as the strip of hook fasteners 506 secured to the lower seal part holding the brush or fibre material 502 as illustrated in FIGS. 8a and 8b. The type of band or sheet 1600 may also be used at the sheets 605 and 1305 of the door sealing assemblies of FIGS. 6 and 13.

A flexible fabric or web like sheet or band similar to the band 1600 but provided with loop fasteners instead of hook fasteners 1601 at a front side is also commercially available and may be made of a plastic material such as nylon. This type of loop band may be used as the flexible fabric or web like sheets 503, 703, 903a, 903b, 1103 and 1203 of FIGS. 5, 7b, 9a, 9b, 11 and 12.

The invention has been described in conjunction with various embodiments herein. However, other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality.

1. A seal combination comprising an upper seal part formed at least partly by a flexible material and a lower seal part holding a brush or fibre material, wherein:
the upper seal part has a length, a width and a maximum thickness, first and second outer sidewalls, a bottom part and a top part, and extends in a longitudinal direction;
the lower seal part has a top part releasably secured to the bottom part of the upper seal part and extends in the longitudinal direction of the upper seal part along said bottom part; and
the top part of the lower seal part is provided with a strip of hook or loop fasteners, and the bottom part of the upper seal part is provided with loop or hook fasteners mating with the strip of hook or loop fasteners provided at the lower seal part to thereby releasably secure the lower seal part to the upper seal part.

2. A seal combination according to claim 1, wherein the upper seal part is provided with loop or hook fasteners by a flexible fabric or web like sheet holding loop or hook fasteners, said flexible fabric or web like sheet being secured to the upper seal part and bent around the bottom part of the upper seal part with the loop or hook fasteners facing outwards from the upper seal part.

3. A seal combination according to claim 1, wherein the top part of the lower seal part is provided with a strip of hook fasteners, and the bottom part of the upper seal part is provided with loop fasteners mating with the strip of hook fasteners provided at the lower seal part to thereby releasably secure the lower seal part to the upper seal part.

4. A seal combination according to claim 3, wherein the upper seal part is provided with loop fasteners by a flexible fabric or web like sheet holding loop fasteners, said flexible fabric or web like sheet being secured to the upper seal part and bent around the bottom part of the upper seal part with the loop fasteners facing outwards from the upper seal part.

5. A seal combination according to claim 2, wherein at least one half, such as at least two thirds of the surface of the first and/or second outer sidewall of the upper seal part is provided with loop or hook fasteners by said flexible fabric or web like sheet.

6. A seal combination according to claim 5, wherein the whole surface of the first and/or second outer sidewall of the upper seal part is provided with loop or hook fasteners by said flexible fabric or web like sheet.

7. A seal combination according to claim 6, wherein the whole surface of both the first and second outer sidewalls of the upper seal part is provided with loop or hook fasteners by said flexible fabric or web like sheet.

8. A seal combination according to claim 1, wherein the length of brush or fibre material of the lower seal part is smaller than or equal to ¼, ⅕ or ⅙ of the width of the upper seal part.

9. A seal combination according to claim 1, wherein the top part of the lower seal part has a width, which is substantially equal to or no larger than the maximum thickness of the upper seal part.

10. A seal combination according to claim 1, wherein the upper seal part is a reinforced flexible seal part comprising:
a flexible outer material; and
a plurality of elongated metal wires embedded in the flexible outer material and running substantially in a longitudinal direction of the reinforced flexible seal part with at least part of said elongated metal wires arranged at a distance to each other.

11. A seal combination according to claim 10, wherein for at least one of the embedded elongated metal the wires, at least part of said metal wire holds several bent, bulging or wavelike deformations in the longitudinal direction of the wire.

12. A seal combination according to claim 10, wherein all the elongated metal members or metal wires of the reinforced flexible seal part are arranged substantially parallel to each other.

13. A seal combination according to claim 12, wherein the successively arranged elongated metal members or metal wires are arranged with substantially equal spacing.

14. A seal combination according to claim 13, wherein the bottom part of the upper seal part has an outer edge, and the spacing between said outer edge and an outermost positioned elongated metal member or metal wire is smaller than said substantially equal spacing.

15. A sealed wall, fence, door, sliding door, port or window assembly for sealing a gap or space between an outer edge of a wall, fence, door, sliding door, port or window and a surface adjacent to the wall, fence, door, sliding door, port or window, said assembly comprising:
a wall, fence, door, sliding door, port or window with an outer edge part; and
a seal combination according to claim 5;
wherein the outer edge part of the wall, fence, door, sliding door, port or window is provided with hook or loop fasteners by a flexible fabric or web like sheet holding hook or loop fasteners, said flexible fabric or web like sheet being secured to said outer edge part with the hook or loop fasteners facing outwards from the outer edge part; and
wherein the upper part of the seal combination is releasably secured to the outer edge part of the wall, fence, door, sliding door, port or window with the loop or hook fasteners provided at the first or second sidewall of the upper seal part mating with the of hook or loop fasteners provided at the outer edge part.

16. A sealed assembly according to claim 15, wherein the outer edge part of the wall, fence, door, sliding door, port or window is provided with hook fasteners by a flexible fabric or web like sheet holding hook fasteners, said flexible fabric or web like sheet being secured to said outer edge part with the hook fasteners facing outwards from the outer edge part; and
wherein the upper part of the seal combination is releasably secured to the outer edge part of the wall, fence, door, sliding door, port or window with the loop fasteners provided at the first or second sidewall of the upper seal part mating with the hook fasteners provided at the outer edge part.

17. A seal comprising an upper seal part formed at least partly by a flexible material and a lower seal part formed by said flexible material, wherein:
the upper seal part has a length, a width and a maximum thickness, first and second outer sidewalls, a bottom part and a top part, and extends in a longitudinal direction;
the lower seal part has a length, a width being smaller than the width of the upper seal part and a lower edge with an edge-thickness which is smaller than the maximum thickness of the upper seal part, said edge-thickness being smaller than or equal to ½, ⅓ or ¼ of the maximum thickness of the upper seal part.

18. A seal according to claim 17, wherein the edge-thickness of the lower seal part is smaller than or equal to ⅕ of the maximum thickness of the upper seal part.

19. A seal according to claim 17, wherein the lower seal part has a thickness, which decreases along the width of the lower seal part from a connection point between the upper seal part and the lower seal part towards the lower edge of the lower seal part.

20. A seal according to claim 17, wherein the length of the lower seal part is substantially equal to the length of the upper seal part.

21. A seal according to claim 17, wherein the width of the lower seal part is smaller than or equal to ¼, ⅕ or ⅙ of the width of the upper seal part.

22. A seal according to claim 17, wherein the upper seal part is a reinforced flexible seal part comprising:
a flexible outer material; and
a plurality of elongated metal wires embedded in the flexible outer material and running substantially in a longitudinal direction of the reinforced flexible seal part with at least part of said elongated metal wires arranged at a distance to each other.

23. A seal according to claim 22, wherein for at least one of the embedded elongated metal the wires, at least part of said metal wire holds several bent, bulging or wavelike deformations in the longitudinal direction of the wire.

24. A seal combination according to claim 22, wherein all the elongated metal members or metal wires of the reinforced flexible seal part are arranged substantially parallel to each other.

25. A seal combination according to claim 24, wherein the successively arranged elongated metal members or metal wires are arranged with substantially equal spacing.

26. A seal combination according to claim 25, wherein the bottom part of the reinforced flexible seal part has an outer edge, and the spacing between said outer edge and an outermost positioned elongated metal member or metal wire is smaller than said substantially equal spacing.

27. A seal according to claim 17, wherein the upper seal part is at least partly provided with loop or hook fasteners by a flexible fabric or web like sheet holding loop or hook fasteners and secured to the upper seal part with the loop or hook fasteners facing outwards from the upper seal part.

28. A seal according to claim 27, wherein at least one third, or at least one half, or such as at least two thirds of the surface of the first and/or second outer sidewall of the upper seal part is provided with loop or hook fasteners by said flexible fabric or web like sheet.

29. A seal according to claim 27, wherein the flexible fabric or sheet is bent around the top part of the upper seal part with the loop or hook fasteners facing outwards from the upper seal part.

30. A seal according to claim 17, wherein a substantially U-shaped metal rail having a length, a bottom wall, and first and second sidewalls is arranged at the upper seal part with the bottom wall covering the top part of the upper seal part, the first sidewall covering a part of the first outer sidewall of the upper seal part, and the second sidewall covering a part of the second outer sidewall of the upper seal part.

31. A seal according to claim 30, wherein at least one third of the surface of the first and second outer sidewall of the upper seal part are covered by the sidewalls of said metal rail.

32. A sealed wall, fence, door, sliding door, port or window assembly for sealing a gap or space between an outer edge of a wall, fence, door, sliding door, port or window and a surface adjacent to the wall, fence, door, sliding door, port or window, said assembly comprising:
a wall, fence, door, sliding door, port or window with an outer edge part; and
a seal according to claim 27;
wherein the outer edge part of the wall, fence, door, sliding door, port or window is provided with hook or loop fasteners by a flexible fabric or web like sheet holding hook or loop fasteners, said flexible fabric or web like sheet being secured to said outer edge part with the hook or loop fasteners facing outwards from the outer edge part; and
wherein the upper part of the seal is releasably secured to the outer edge part of the wall, fence, door, sliding door, port or window with the loop or hook fasteners provided at the first or second sidewall of the upper seal part mating with the of hook or loop fasteners provided at the outer edge part.

33. (canceled)

34. (canceled)
